(19) United States
(12) Patent Application Publication
(10) Pub. No.: US 2008/0147926 A1
(43) Pub. Date: Jun. 19, 2008

(54) Interface conversion device

(75) Inventor: Huang-Liang Chen, Taipei County (TW)

Correspondence Address: BIRCH STEWART KOLASCH & BIRCH, PO BOX 747, FALLS CHURCH, VA, 22040-0747, US

(73) Assignee: Mitac International Corp.

(21) Appl. No.: 11/582,363

(22) Filed: Oct. 18, 2006

(51) Int. Cl. G06F 13/38

(52) U.S. Cl. 710/62

(57) ABSTRACT

An interface conversion device is provided to connect a peripheral device and a serial peripheral interface (SPI) of the CPU by using a complex programmable logic device. The peripheral device transmits data to the complex programmable logic device. The complex programmable logic device receives the data by using a universal asynchronous receiver transmitter (UART), converts the data into the data that can be accepted by a serial peripheral interface by using an interface conversion unit, and then transmits the data to a central processing unit (CPU). The CPU transmits the data to the complex programmable logic device, and the complex programmable logic device also converts the data into the data that can be accepted by the universal asynchronous receiver transmitter by using the interface conversion unit, and then transmits the data to the peripheral device.

### BACKGROUND OF THE INVENTION

1. Field of Invention

The present invention relates to an interface conversion device, and more particularly, to an interface conversion device for achieving the conversion between a universal asynchronous receiver transmitter (UART) and a serial peripheral interface (SPI) by using a complex programmable logic device.

2. Related Art

Current CPU only provides two universal asynchronous receiver transmitters (UART) which are usually used in a blue tooth (BT) device and a global positioning system (GPS), respectively. When an additional peripheral device must take the UART as a transmission link interface, the current two UARTs are not sufficient in use.

The conventional technology takes the serial peripheral interface (SPI) of a CPU as another transmission link interface, but the peripheral device has to be coupled to a transfer IC, so as to achieve the conversion between the UART and the SPI. However, there are specific limitations on some products, for example, a printed circuit board is full of elements arranged thereon and thus in a saturation state, and the size of the printed circuit board cannot be enlarged and no element can be removed; thus, there is no more space to add even one transfer IC into the product. Therefore, how to solve the problem of the expansion of the UART becomes a subject for those skilled in the art to study firstly.

### SUMMARY OF THE INVENTION

In order to solve the above problem, the present invention utilizes an existing complex programmable logic device on a printed circuit board to expand the UART without an additional transfer IC.

The present invention utilizes the programmable characteristics of the complex programmable logic device to accommodate the UART and an interface conversion unit in the complex programmable logic device, utilizes the corresponding connection between the UART and an additional peripheral device to transmit data between the peripheral device and the complex programmable logic device, and then utilizes the interface conversion unit to convert the data into the data that can be accepted by an SPI and then transmit it to a CPU. In another aspect, the CPU transmits the data to the complex programmable logic device through the SPI, and also converts the data into the data that can be accepted by the UART by using the interface conversion unit, and then transmits the data to the peripheral device.

The present invention can solve the problem that other transfer ICs cannot be added due to the insufficient arrangement space of the printed circuit board, and achieves the objective of expanding the UART by fully using the characteristics of the existing complex programmable logic device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

It is to be understood that, both the above description of the content of the present invention and the following detailed description intend to demonstrate and illustrate the principle of the invention, and to provide further explanation of the invention as claimed.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a preferred embodiment of the present invention.

### DETAILED DESCRIPTION OF THE INVENTION

The detailed features and advantages of the present invention will be described below in the detailed description of the present invention, and those skilled in the art will understand the technology from the contents and then carry it out accordingly. Furthermore, according to the contents stated in the specification, the claims, and the drawing, those skilled in the art will easily understand the objectives and advantages of the present invention.

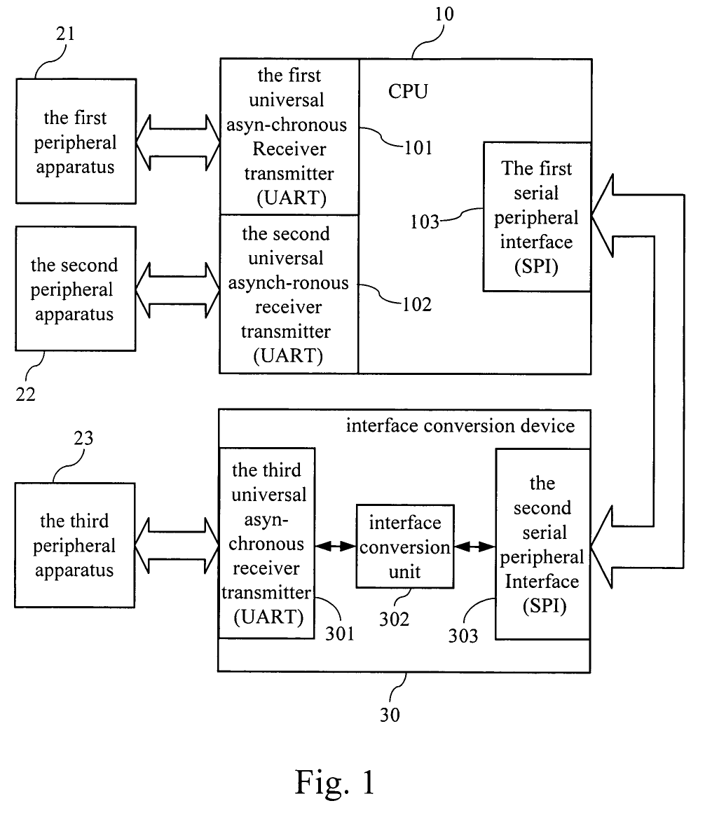

Please refer to FIG. 1 of a block diagram of a preferred embodiment of the present invention. As shown in FIG. 1, a CPU 10, an interface conversion device 30, and a plurality of other electronic components (not shown) are disposed on a printed circuit board (not shown). The CPU 10 comprises a first UART 101, a second UART 102, and a first SPI 103, and is connected to a first peripheral device 21 and a second peripheral device 22 by using the first UART 101 and the second UART 102, respectively.

The interface conversion device 30 is a complex programmable logic device (CPLD), which is a programmable circuit structure. The present invention utilizes the programmable characteristics of the CPLD to design the interface conversion device 30 with a third UART 301, an interface conversion unit 302, and a second SPI 303 by a hardware language. According to one specific embodiment of the present invention, the CPLD is an existing device on the printed circuit board, but not the new device provided by the present invention for achieving the objective. The technical means of the present invention is a design to expand the function of the CPLD to solve the problem.

Furthermore, the interface conversion device 30 is connected to a third peripheral device 23 by using the third UART 301, and is connected to the first SPI 103 of the CPU 10 by using the second SPI 303. The third peripheral device 23 transmits data to the interface conversion device 30 through the third UART 301. Then, the interface conversion device 30 converts the format of the data into the data format that can be accepted by the SPI by using the interface conversion unit 302, and transmits the data with the format changed to the CPU 10 through the second SPI 303 and the first SPI 103. In another aspect, the data in the CPU 10 is transmitted to the interface conversion device 30 via the first SPI 103. After the data is received by the second SPI 303, the interface conversion device 30 also converts the format of the data into the data format that can be accepted by the UART by using the interface conversion unit 302, and transmits the data with the format changed to the third peripheral device 23 through the third UART 301. Thereby, in the present invention, through the CPLD, the third peripheral device 23 is correspondingly connected to the third UART 301 of the PLD, so as to mutually transmit data with the first SPI 103 of the CPU 10.

In a non-limited example, the first UART 101, the second UART 102, and the third UART 301 are bridged to the first peripheral device 21, the second peripheral device 22, and the third peripheral device 23 through RS232, RS422, or RS485 serial interfaces, respectively.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An interface conversion device, comprising:
an interface conversion unit;
a universal asynchronous receiver transmitter (UART), connected to a peripheral device; and
a serial peripheral interface (SPI), connected to a central processing unit (CPU);
wherein the interface conversion device converts data transmitted from the peripheral device into the data that is accepted by the SPI through the interface conversion unit, and then transmits the data to the CPU; and the interface conversion device converts the data of the CPU into the data that is accepted by the UART through the interface conversion unit, and then transmits the data to the peripheral device.

2. The interface conversion device as claimed in claim 1, wherein the interface conversion device is a complex programmable logic device.

3. The interface conversion device as claimed in claim 1, wherein a serial interface is further provided for being connected between the peripheral device and the interface conversion device.

4. The interface conversion device as claimed in claim 3, wherein the serial interface is selected from a group consisting of a RS 232 serial interface, a RS 422 serial interface, and a RS 485 serial interface.
